(19) United States
(12) Patent Application Publication
(10) Pub. No.: US 2008/0075955 A1
(43) Pub. Date: Mar. 27, 2008

(54) Shrink sleeve label with thermo-reactive adhesive and method of making the same

(76) Inventor: Neil G. Sellars, Cinnaminson, NJ (US)

Correspondence Address: REED SMITH LLP, 2500 ONE LIBERTY PLACE, 1650 MARKET STREET, PHILADELPHIA, PA, 19103, US

(21) Appl. No.: 11/903,516

(22) Filed: Sep. 21, 2007

Related U.S. Application Data
(60) Provisional application No. 60/846,409, filed on Sep. 21, 2006.

(51) Int. Cl. B32B 7/12; B32B 37/12

(52) U.S. Cl. 428/347; 156/277

(57) ABSTRACT

The present invention includes a shrink sleeve label with thermo-reactive adhesive and method of making such a label suitable for labeling objects having peripheries. The label includes shrink film wherein the shrink film has a first surface and a second surface, thermo-reactive adhesive, indicia, and security and tamper evidence features. The thermo-reactive adhesive lies adjacent to at least a portion of the second surface of the shrink film and the thermo-reactive adhesive forms a bond to the second surface of the shrink film. The indicia may exist on at least one or both of the first and second surfaces of the shrink film.

### RELATED APPLICATION

This application claims priority of U.S. patent application Ser. No. 60/846,409, filed Sep. 21, 2006, entitled “Shrink Sleeve Label with Thermo-Reactive Adhesive,” the entire disclosure of which is hereby incorporated by reference as if being set forth in its entirety herein.

### FIELD OF THE INVENTION

The present invention relates generally to labels and, more particularly, to shrinkable labels for products and product containers.

### BACKGROUND OF THE INVENTION

Labels, typically in the form of a flexible sheet or web material attached to an object, have long been used to identify the object, its contents, and/or display other information associated with the object. Such labels, which are normally fabricated from paper or plastic, are usually adhesively secured to the object by a contact or pressure sensitive adhesive material. Many types of labels have been fabricated for objects, specifically containers, that have a circumference or perimeter. Furthermore, widespread use and manufacturing of labels for single-use or disposable containers have lead to the development of shrink sleeve labels. Shrink sleeve labels usually are made of a thin polyvinyl chloride (PVC), polyethylene terephthalate, PETg, oriented polypropylene (OPP), or oriented polystyrene (OPS) film that is adhered to the perimeter of a container via shrinking the film in conjunction applying a small amount of adhesive or no adhesive at all.

Such shrink sleeve labels allow for the printing of graphics and indicia on them and can be a more economical means of labeling because little or no adhesive may be used in adhering the labels to containers than other conventional labeling methods. Recently, shrink sleeve labels have been used for printing highly complex, multi-color graphics. Thus, shrink sleeve labels are an economical means for providing visually complex labels and, therefore, are often found on single-use or disposable containers, such as beverage bottles. Such shrink sleeve labels are also easy to remove, which makes the recycling of containers with a shrink sleeve label easier. In many cases, shrink sleeve labels are easy to remove because they are applied to containers with little or no adhesive.

However, in some instances, it is not acceptable for a label to be so easily removed. Many objects and containers require their labels to remain in tact for as long as possible in order to provide verification of the objects or contents of the containers which the labels are marking. Thus, a label is needed which forms as bond with the object or container that it covers such that removing the label would either be very hard or would cause destruction of the label. In other instances, it is vital to know if a label has been removed and another label applied in its place. For example, some labels used to label pharmaceutical and medication containers need to be difficult to remove and/or have security features so that a person working with the medication can be sure that the medication is what the label says it is and that it has not been tampered with or compromised in some way. The currently available shrink sleeve labels are not acceptable for pharmaceutical and medication containers because they are easily removed and have no security features. Thus, a need exists for a label that may be printed with complex graphics and indicia, such as; a shrink sleeve label, but also is very difficult to remove and provides security features.

The details of the present invention in overcoming the aforementioned limitations of the prior art will become apparent as the following description of the embodiments of the invention proceeds.

### SUMMARY OF THE INVENTION

The present invention includes a shrink sleeve label with thermo-reactive adhesive and method of making such a label suitable for labeling objects having peripheries. The label includes shrink film wherein the shrink film has a first surface and a second surface, thermo-reactive adhesive, indicia, and security and tamper evidence features. The thermo-reactive adhesive lies adjacent to at least a portion of the second surface of the shrink film and the thermo-reactive adhesive forms a bond to the second surface of the shrink film. The indicia may exist on at least one or both of the first and second surfaces of the shrink film. Furthermore, the label includes both security and tamper evidence features, such as taggants, holograms, and other tamper evidence features that are not visible when the label is affixed about an object.

The method of making such label includes providing shrink film, wherein the shrink film has a first surface, second surface, left lateral edge, right lateral edge, top edge, and bottom edge; printing indicia on at least one or both of the first and second surfaces of the shrink film; applying thermo-reactive adhesive to the second surface of the shrink film; connecting the first lateral edge together with the second lateral edge to form a sleeve, wherein the first surface of the shrink film faces outward from the sleeve; seaming the first lateral edge with the second lateral edge; and subjecting the sleeve to heat, wherein the heat causes the shrink film to shrink and the thermo-reactive adhesive to cure.

### DESCRIPTION OF THE FIGURES

Understanding of the present invention will be facilitated by consideration of the following detailed description of the preferred embodiments of the present invention taken in conjunction with the accompanying figures, in which like numerals refer to like parts:

FIG. 1 is an exploded view of one embodiment of a shrink sleeve label with thermo-reactive adhesive in accordance with the present invention;

FIG. 2 is an exploded view of another embodiment of a shrink sleeve label with thermo-reactive adhesive in accordance with the present invention;

FIG. 3 is a view of one embodiment of a shrink sleeve label with thermo-reactive adhesive in accordance with the present invention showing the non-adhesive surface of such label;

FIG. 4 is a view of another embodiment of a shrink sleeve label with thermo-reactive adhesive in accordance with the present invention showing the adhesive surface of such label;

FIG. 5 is a schematic depicting one way in which the labels of this invention may be made; and

FIG. 6 is an illustration of a one embodiment of a shrink sleeve label with thermo-reactive adhesive in accordance with the present invention showing such label after it has been applied to a container.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in labels and labeling systems. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

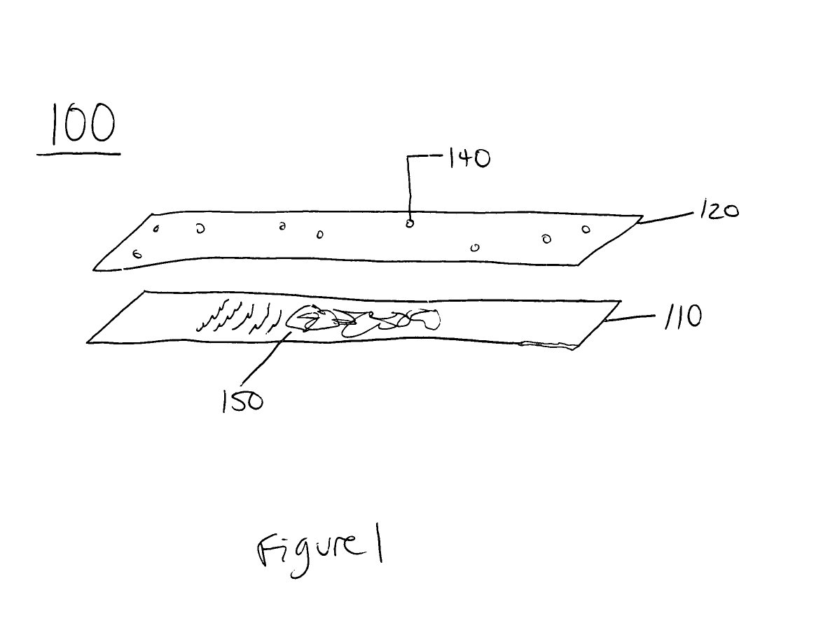

Referring to FIG. 1, there is shown an illustration of an exploded view of a shrink sleeve label with thermo-reactive adhesive in accordance with an embodiment of the present invention, in which the thermo-reactive adhesive may, for example, be a composition having adhesive properties which are activated by heat. Such label 100 may be suitable for application to the outside wall of an object such as a bottle, jar, or any other sort of container with a periphery. Such container may be made of any material that is conventionally used in making containers. As illustrated, label 100 may be constructed as an elongated strip. Label 100 may be constructed of at least two layers, the first layer being shrink film 110 with the second layer being thermo-reactive adhesive 120. Shrink film 110 may be composed of commercially available PVC, PET, PETg, OPP, OPS, or polylactide (PLA) shrink film and may shrink generally in the transverse (cross direction) when exposed to heat. Such PVC and PETg shrink films may have excellent ability to be printed upon and high transverse-direction orientation (TDO) which allows both films to shrink uniformly around a container when exposed to enough uniform heat. Optionally, the PVC shrink film may be clear and have a high gloss and thickness of between 45 and 70 micrometers. In some cases, it may be desirable for the PETg shrink film to be clear or opaque white, with the opaque white PETg shrink film having a thickness of about 50 micrometers and the clear PETg shrink film having a thickness of between 45 and 50 micrometers. Such PVC, PET, PETg, OPP, OPS, or polylactide (PLA) films may have properties which allow the majority of shrinkage to be only in one direction when the films are subjected to uniform heat.

Shrink film 110 may have indicia 150 on either or both of its two surfaces. For example, one may choose to print on the side of the shrink film on which the thermo-reactive adhesive is to be placed and, in this case, indicia 150 may be seen through clear film 110. Such indicia 150 may be printed backwards or as a mirror image such that, if viewed through the clear shrink film, such indicia would read properly. In addition, such shrink film may be printed with expanded or distorted images and/or indicia in order to account for the predictable shrinkage of the shrink film while heating such that a readable or desired image and indicia result after heating. If opaque shrink film 110 is used, it may be desirable to print shrink film 110 with indicia 150 on both surfaces of shrink film 110, which may allow shrink film 110 to contain both outside indicia (which may be visible when label 100 is affixed to a container) and inside indicia (which is printed on the surface of shrink film 110 that also contains thermo-reactive adhesive 120 and may not be visible when label 100 is affixed to a container). Such a configuration may provide tamper evidence features to label 100. The outside indicia may be any kind of indicia, preferably indicia used to identify the contents of a container and graphics to accompany the identification. Such inside indicia may be indicia that may only be viewed when label 100 is removed from a container subsequent to label 100 being affixed to such container.

Thermo-reactive adhesive 120 may be a water-based dispersion of high-molecular-weight ethylene copolymers. Ashland may be one such supplier of such high-molecular-weight ethylene copolymers. Thermo-reactive adhesive 120 may also contain taggants 140, which may be chemical markers that are incorporated into thermo-reactive adhesive 120 or by putting a small amount of taggant material in one place in thermo-reactive adhesive 120 or on shrink film 110 before thermo-reactive adhesive 120 is applied to shrink film 110. Such taggants 140 are special chemicals that have unique properties such that they can only be detected by specialized readers. Such specialized readers may detect the presence of taggants 140 by conventional means including directing light or other radiation into taggants and reading the properties of the taggants that are returned when the taggants are present. In some cases, taggants may be read by reading the taggants' optical properties.

Such taggants 140 are available commercially from several manufacturers. For example, Inksure Technologies makes a variety of taggants and readers as working systems. Taggants 140 may be used to create a “fingerprint” in thermo-reactive adhesive 120. Then, if a taggant reader that is made to read only a specific taggant is used and detects a taggant, a method of verifying the identity of a label or a container's label may be possible. Taggants 140 can be used as a covert means of adding a security feature to label 100 because taggants 140 are of a type not visually detectable with anything other than a specialized taggant reader. Thus, taggants 140 may provide authenticity verification to a user of label 100 by the taggants 140. If taggants 140 were not detected in a label read with a specialized reader, then a user may alerted that such label may be counterfeit.

Such thermo-reactive adhesive 120 may preferably be applied in liquid form directly to shrink film 110 and allowed to dry. Alternatively, thermo-reactive adhesive 120 may be applied to shrink film 110 in dry form from a release liner by contacting dry thermo-reactive adhesive 120 to shrink film 110 and subsequently removing the release liner.

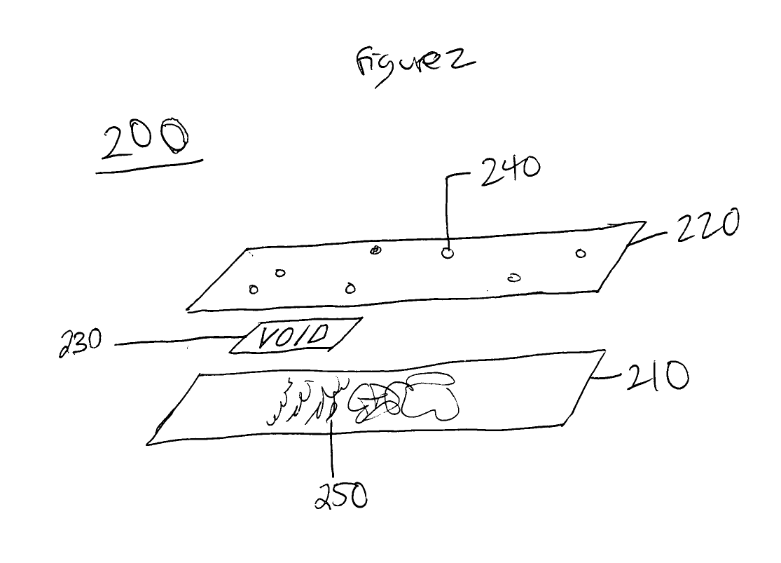

Referring now to FIG. 2, there is shown an illustration of an exploded view of another shrink sleeve label with thermo-reactive adhesive in accordance with another embodiment of the present invention. Such label 200 may have shrink film 210, thermo-reactive adhesive 220, taggants 240, and indicia 250, of which can be made of materials as previously in connection with Label 100. Label 200 may be applied to the same sort of objects and containers as described above in connection with label 100. Label 200 may have an additional layer 230 which may be a means of making tampering evident. Layer 230 may be a substrate which has indicia such as “VOID” printed on it such that it may only be viewed when label 200 is removed from a container subsequent to label 200 being affixed to such container and may make the removal of label 200 evident. This may be accomplished by use of conventional techniques, such as printing, which are known in the art. Such layer 230 may cause part of its indicia to remain on label 200 and part to remain on a container when label 200 is removed from the container, thus, providing evidence of tampering with label 100.

Thermo-reactive adhesive 120 and 220 in FIGS. 1 and 2 respectively may be applied to shrink films 110 and 210 in conventional ways, such as via rotogravure, rotary screen, flexographic means, or any other suitable method.

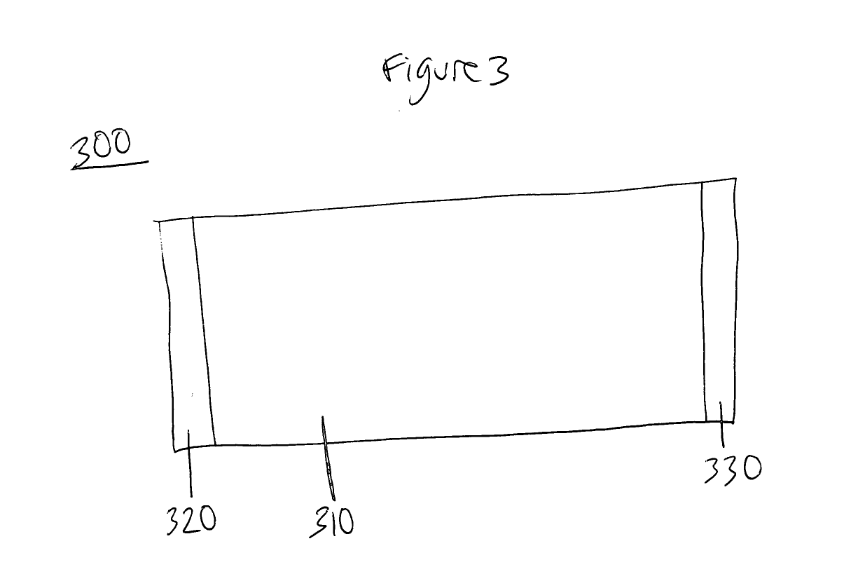

Referring now to FIG. 3, there is shown an illustration of the non-adhesive surface of a shrink sleeve label with thermo-reactive adhesive in accordance with an embodiment of the present invention. Surface 310 may be the non-adhesive side of labels 100 or 200 as described above. Thus, the thermo-reactive adhesive in FIG. 3 is not visible. Label 300 may have seaming areas 320 and 330 at the far left and right ends of label 300, which may exist in varying lengths and widths. Such seaming areas 320 and 330 provide lengths of label 300 for either a small amount of overlap or conjoining area in order to allow label 300 to be secured about a container. Preferably, label 300 is folded and one or more seaming areas are coated with seaming solution on either surface of label 300. Then, seaming areas 320 and 330 are conjoined and thereby connected via the seaming solution so as to form a sleeve out of label 300. Seaming areas 320 and/or 330 may be coated with a seaming solution such as tetrahydofuran (THF) or other materials that are known and used in the labeling industry. Preferably, seaming areas 320 and 330 are not covered with thermo-reactive adhesive. Once label 300 is folded and seamed, a sleeve may be formed from label 300 with the thermo-reactive adhesive on the inside of such sleeve.

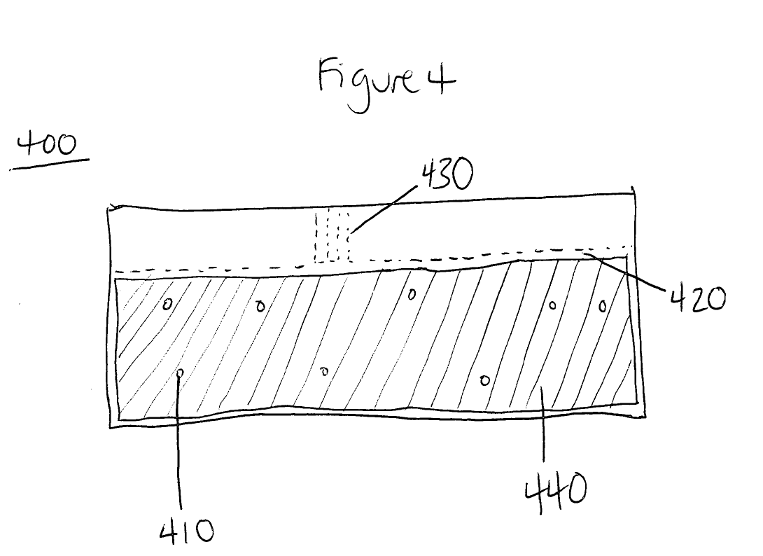

Referring now to FIG. 4, there is shown an illustration of the adhesive surface of a shrink sleeve label with thermo-reactive adhesive in accordance with an embodiment of the present invention. FIG. 4 illustrates the adhesive side of labels, according to the invention, such as 100, 200, or 300. Thus, the thermo-reactive adhesive 440 in FIG. 3 is visible. Taggants 410 may also exist in thermo-reactive adhesive 440 in one embodiment of the present invention. Label 400 may have perforations 420 and 430 in the shrink film of label 400 just above thermo-reactive adhesive 440 and some distance below the top edge of label 400.

Perforations 420 may provide a tamper evidence feature to label 400. In one embodiment of the present invention, a width of the label above perforations 420 may or may not be covered with thermo-reactive adhesive and, when label 400 is applied to a container, such width of the label may serve to cover the top of the container, such as the container's cap area, lid, or neck. Any attempt to remove the top of a container, lid, or cap may cause label 400 to tear at perforations 430, thus showing evidence of attempts to remove a container's lid or cap.

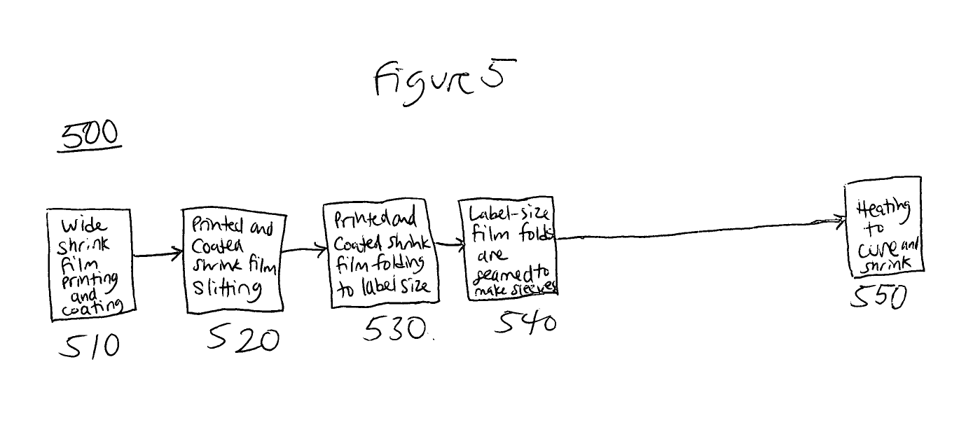

Referring now to FIG. 5, there is shown a schematic of one way in which a shrink sleeve label with thermo-reactive adhesive may be made. In step 510, wide rolls of shrink film may be unwound and subjected to a machine which imparts indicia on either or both surfaces of the shrink film. Such imparting of indicia on the shrink film is known in the art. Also in step 510, the thermo-reactive adhesive may be applied to the shrink film. The step of applying thermo-reactive adhesive may take place before or after the shrink film is printed. If the thermo-reactive adhesive is applied first, the thermo-reactive adhesive may be allowed to dry before the shrink film is subjected to the printing process. If it is desired that the thermo-reactive adhesive contain taggants, such taggants may be added to the thermo-reactive adhesive at an earlier point, which may then be applied to the shrink film. In another embodiment, such taggants may be applied directly to the shrink film in one or more places before, during, or after the printing process. If it is desired that a tamper evidence feature be added to the shrink film at this point, such tamper evidence feature (such as a substrate containing indicia such as “VOID,” as described above) may be placed on the shrink film before the thermo-reactive adhesive is applied to the shrink film.

In step 520, the shrink film is dried. Drying the thermo-reactive adhesive may allow the shrink film to be rewound to prevent the thermo-reactive adhesive from sticking to other surfaces. Also in step 520, the wide width shrink film may be preferably cut down to narrower widths and may even be slit down to label-size. Such slitting may be accomplished with slitting processes, operations, and machines that are conventionally known and used in the art.

In step 530 of method 500, the shrink film may be folded to produce a sleeve, with the surface of the shrink film with the thermo-reactive adhesive on it is on the inside of the sleeve, which may be ready for seaming. Such folding may be accomplished with folding processes, operations, and machines as known and used in the art.

In step 540 of method 500, the folded shrink film may preferably be subjected to a seaming process wherein seaming solution is added to one or more edges of the shrink film and the edges of the shrink film are seamed to produce a seamed sleeve. Such seaming may be accomplished with conventional seaming processes, operations, and machines as are known and used in the art.

In step 550 of method 500, objects or containers with the seamed shrink film sleeves on them may preferably be subjected to uniform heat wherein the shrink film sleeves shrink about the objects or containers to end up with a container with a form-fitting label. In addition to shrinking the film, such heating process also may cause the thermo-reactive adhesive to cure, producing a bond between the shrink film and the container. Such heating and shrinking process may be accomplished with conventional heating processes, operations, and machines as are known and used in the art. The labeled container is then available for sale or shipment or further processing.

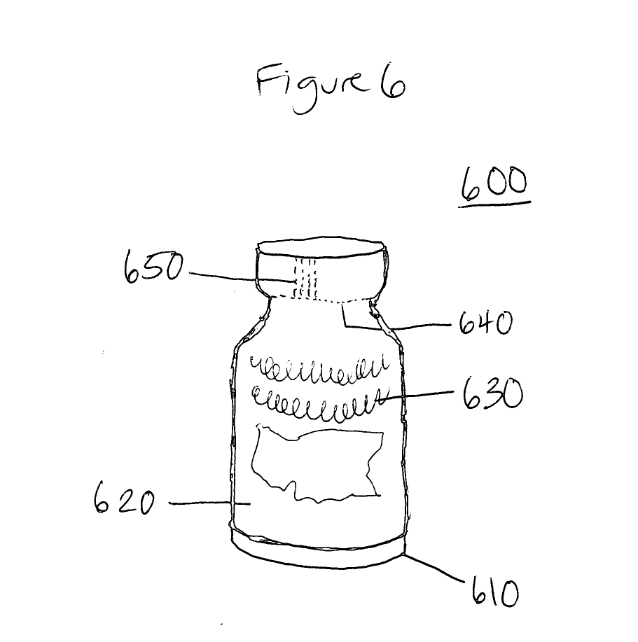

Referring now to FIG. 6, there is illustrated one embodiment of a shrink sleeve label with thermo-reactive adhesive in accordance with the present invention as it may appear after step 550 in method 500, after it has been applied to a container. In FIG. 6, container 610 may be of almost any shape or size as long as such container has a periphery. Shrink sleeve label 620 may be suitable for almost any size and shape container because the shrinking process may allow shrink film of the shrink sleeve label 620 to conform to many different sizes and shapes. Shrink sleeve label 620 may include indicia 630 and perforations 640 for evidencing tampering, as described herein above. Shrink sleeve label 620 may or may not further include perforations 650 for allowing easy removal of container 620's cap or lid, allowing the user to easily tear the top portion of shrink sleeve label 620 away.

Any of the labels described herein above may further comprise other security features such as holograms or any combination of security features which are known and used in the art. Such shrink sleeve thermo-reactive adhesive labels may be of many different sizes and shapes, as is conventional in the labeling industry and as one skilled in the art of labeling knows. Any of the labels described herein above may have varying amounts of thermo-reactive adhesive on them in order to allow a user to design a label for any specific container or purpose. Any of the labels described herein above may have thermo-reactive adhesive existing on them in patterns. Furthermore, any of the labels described herein above may have any, all, or some of the security and tamper evidence features described herein above, thus allowing a label designer to select certain security or tamper evidence features or decline to design a label employing any of them.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A shrinkable label having a length which is suitable to be wrapped about a container, said label comprising:
shrink film, wherein said shrink film has a first surface and a second surface, and wherein said shrink film shrinks along the length of the label when exposed to heat;
thermo-reactive adhesive, wherein the thermo-reactive adhesive lies adjacent to at least a portion of said second surface of the shrink film, wherein said thermo-reactive adhesive adheres to said second surface and which adheres to the container upon heating; and
indicia, wherein said indicia exists on at least one of said first surface or said second surface of said shrink film.

2. The label of claim 1, wherein the thermo-reactive adhesive is applied in al pattern.

3. The label of claim 1, further comprising at least one kind of taggant, wherein said at least one taggant is invisible and detectable only with a reader designed to detect said taggant and wherein said taggant may exist in said thermo-reactive adhesive or on said shrink film.

4. The label of claim 1, further comprising horizontal perforations in said shrink film wherein said perforations are a means for making tampering with said label evident.

5. The label of claim 1, further comprising vertical perforations in said shrink film wherein said vertical perforations are a means for easily tearing said shrink film.

6. The label of claim 1, further comprising a tamper evidencing feature located in between said shrink film and said thermo-reactive adhesive.

7. The label of claim 6, wherein said tamper evidencing feature comprises:
a substrate; and
indicia, wherein said indicia is printed on the substrate, and wherein at least some of the indicia will remain on the thermo-reactive adhesive and container when said label is removed from the container.

8. The label of claim 6, wherein said tamper evidencing feature comprises:
a substrate; and
indicia, wherein said indicia is printed on the substrate, and wherein at least some of the indicia will remain on the shrink film when said label is removed from the container.

9. The label of claim 6, wherein said tamper evidencing feature comprises:
a substrate; and
indicia, wherein said indicia is printed on the substrate, and wherein at least some of the indicia will destruct when said label is removed from the container.

10. The label of claim 1, wherein said shrink film comprises one selected from the group consisting of PVC, PET, PETg, OPP, OPS, and PLA.

11. The label of claim 1, wherein said thermo-reactive adhesive comprises a water-based dispersion of high molecular weight ethylene copolymers.

12. The label of claim 1, further comprising a hologram, wherein said hologram exists on said first surface of said shrink film.

13. A method of making a shrinkable label having a length which is suitable to be wrapped about a container, comprising the steps of:
providing shrink film, said shrink film and having a first surface, second surface, left lateral edge, right lateral edge, top edge, and bottom edge, wherein said shrink film shrinks along the length of the label when exposed to heat;
printing indicia on at least one of said first surface and said second surface of said shrink film;
applying thermo-reactive adhesive to said second surface of said shrink film;
connecting said first lateral edge together with said second lateral edge to form a sleeve, wherein said first surface of said shrink film faces outward from said sleeve; and
seaming said first lateral edge with said second lateral edge.

14. The method of claim 13, further comprising the step of incorporating at least one kind of taggant in said thermo-reactive adhesive or applying at least one kind of taggant to said shrink film, wherein said at least one taggant is invisible and detectable only with a reader designed to detect said taggant and wherein said taggant may exist.

15. The method of claim 13, wherein the step of applying the thermo-reactive adhesive further comprises applying the thermo-reactive adhesive in a pattern.

16. The method of claim 13, further comprising the step of perforating said shrink film.

17. The method of claim 13, further comprising inserting a tamper evidencing feature between said shrink film and said thermo-reactive adhesive.

18. The method of claim 17, wherein said tamper evidencing feature comprises:
a substrate; and
indicia, wherein said indicia is printed on the substrate, and wherein at least some of the indicia will remain on the thermo-reactive adhesive and container when said label is removed from the container.

19. The method of claim 17, wherein said tamper evidencing feature comprises:
a substrate; and
indicia, wherein said indicia is printed on the substrate, and wherein at least some of the indicia will remain on the shrink film when said label is removed from the container.

20. The method of claim 17, wherein said tamper evidencing feature comprises:
a substrate; and
indicia, wherein said indicia is printed on the substrate, and wherein at least some of the indicia will destruct when said label is removed from the container.

21. The method of claim 13, wherein said shrink film comprises one selected from the group consisting of PVC, PETg, PET, OPP, OPS, and PLA.

22. The method of claim 13, wherein said thermo-reactive adhesive comprises a water-based dispersion of high molecular weight ethylene copolymers.

23. The method of claim 13, further comprising the step of adding a hologram to said shrink film, wherein said hologram exists on said first surface of said shrink film.
